(19) United States
(12) Patent Application Publication
(10) Pub. No.: US 2023/0072255 A1
(43) Pub. Date: Mar. 9, 2023

(54) PRIOR ADJUSTED VARIATIONAL AUTOENCODER

(71) Applicant: SAP SE, Walldorf (DE)

(72) Inventors: Tassilo Klein, Berlin (DE); Moin Nabi, Berlin (DE); Jan Nikolas Morshuis, Muenster (DE)

(21) Appl. No.: 17/405,859

(22) Filed: Aug. 18, 2021

(51) Int. Cl. G06N 3/08; G06N 3/04

(52) U.S. Cl. CPC G06N 3/08; G06N 3/0454

(57) ABSTRACT

Aspects of the current subject matter are directed to a variational encoder that takes into account group characteristics of data elements of a dataset. For example, a prior adjusted variational autoencoder takes into account that not all attributes in the dataset naturally follow a normal Gaussian distribution N(0,1). To illustrate by way of an example, data from the dataset may be separated into groups in which elements in a group share group characteristics; for each group, a group representation N(mu_g, sigma_g) is calculated. And, for example, other attributes of data in the dataset do not depend on the group, and the associated data elements continue to follow the normal Gaussian distribution N(0,1). The representation may introduce a flexibility in which encodings of group-related attributes will be encoded close together in the content part instead of being close to an arbitrarily chosen point.

### BACKGROUND

Machine learning models can be used by computer processors to automatically learn (e.g., progressively improve performance on a specific task) from data. The learning can be unsupervised, in which the computer processors learn from training data that has not been labeled, classified, or categorized. Unsupervised learning identifies commonalities in the data and reacts based on the presence or absence of such commonalities in each new piece of data. Auto encoders can be trained to perform unsupervised learning. An autoencoder is a type of generative neural network used to learn efficient data coding in an unsupervised manner. A variational autoencoder is a type of autoencoder in which attributes for an input are represented in a probabilistic distribution.

### SUMMARY

Methods, systems, and articles of manufacture, including computer program products, are provided for a variational encoder that takes into account group characteristics of data elements of a dataset.

According to an aspect of the current subject matter, a system includes a memory storing a data structure including a machine learning model. The machine learning model is configured to receive, by an encoder of a variational autoencoder, a data batch of a dataset, the data batch including data elements; determine, based on encoding of the data elements, a group representation for a group in the data batch, the encoding including a mean and a variance for a probability distribution of the data elements, the group representation including a group probability distribution based on a group mean and a group variance; sample a latent variable from the encodings of the data elements of a first part of a latent space and a second part of the latent space; and generate, by a decoder of the variational autoencoder, reconstructed data based on the latent variable, the reconstructed data characterizing a reconstruction of the dataset.

According to an inter-related aspect, a method includes receiving, by an encoder of a variational autoencoder, a data batch of a dataset, the data batch including data elements; determining, based on encoding of the data elements, a group representation for a group in the data batch, the encoding including a mean and a variance for a probability distribution of the data elements, the group representation including a group probability distribution based on a group mean and a group variance; sampling a latent variable from the encodings of the data elements of a first part of a latent space and a second part of the latent space; and generating, by a decoder of the variational autoencoder, reconstructed data based on the latent variable, the reconstructed data characterizing a reconstruction of the dataset.

According to an inter-related aspect, a non-transitory computer readable medium is provided, the non-transitory computer readable medium storing instructions, which when executed by at least one data processor, result in operations including receiving, by an encoder of a variational autoencoder, a data batch of a dataset, the data batch including data elements; determining, based on encoding of the data elements, a group representation for a group in the data batch, the encoding including a mean and a variance for a probability distribution of the data elements, the group representation including a group probability distribution based on a group mean and a group variance; sampling a latent variable from the encodings of the data elements of a first part of a latent space and a second part of the latent space; and generating, by a decoder of the variational autoencoder, reconstructed data based on the latent variable, the reconstructed data characterizing a reconstruction of the dataset.

In some variations, one or more of the features disclosed herein including the following features can optionally be included in any feasible combination. The encoder may encode the data elements of the data batch, the encoding including determining the mean and the variance for the probability distribution of the data elements. The first part of the latent space may include content attributes of the dataset, the content attributes sharing one or more group characteristics, where the second part of the latent space includes style attributes of the dataset. The machine learning model may be further configured to train the encoder to find representations for the data elements of the dataset, and encode the data elements that share a group close together in the first part of the latent space. A representation of the data elements associated with the style attributes are distributed in accordance with a normal Gaussian distribution having a mean of zero and a variance of one. The data elements associated with the style attributes are distributed according to a normal Gaussian distribution having a mean of zero and a variance of one. The machine learning model may be further configured to determine a loss calculation for the group, the loss calculation including a loss quantification of the first part of the latent space and of the second part of the latent space, where the loss calculation of the first part of the latent space is based on group information. The probability distribution may be determined based on group-level supervision. The encoder may include a first neural network, and the decoder may include a second neural network.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates aspects of a system including a prior adjusted variational autoencoder consistent with implementations of the current subject matter;

FIG. 2 illustrates aspects of an example implementation of a prior adjusted variational autoencoder consistent with implementations of the current subject matter;

FIG. 3 illustrates additional aspects of an example implementation of a prior adjusted variational autoencoder consistent with implementations of the current subject matter;

FIG. 4 is a diagram depicting an example data representation consistent with implementations of the current subject matter;

FIG. 5 depicts a flowchart illustrating a process consistent with implementations of the current subject matter; and

FIG. 6 depicts a block diagram illustrating a computing system consistent with implementations of the current subject matter.

Like labels are used to refer to same or similar items in the drawings.

### DETAILED DESCRIPTION

Aspects of the current subject matter are directed to a variational autoencoder that takes into account group characteristics of data elements.

Variational autoencoders (also referred to as VAEs) are a method in machine learning used for generative tasks or to find low-dimensional representations of high-dimensional data. Variational autoencoders aim to produce a representation of the input data that follows a standard normal Gaussian distribution N(0,1), a normal distribution with a mean of 0 and a variance of 1. For example, a variational autoencoder may be trained on a dataset to generate latent attributes that are distributed similar to a normal Gaussian distribution N(0,1). When decoding the latent attributes, a point in the latent attribute distribution (e.g., the approximately normal distribution) is sampled to generate the multidimensional input to a decoder.

A dataset that includes, as one example, numerical digits may have some continuous attributes, such as line thickness or writing angle, that may be represented with a continuous distribution, for example a normal Gaussian distribution N(0,1). However, a normal Gaussian distribution N(0,1) may not be a natural and/or appropriate distribution for other attributes of the dataset. Other attributes of the dataset may be inherently discrete. For example, the way the digit is written may depend on the digit class, which is a discrete attribute and is therefore difficult to represent with a normal Gaussian distribution N(0,1). If the normal Gaussian distribution N(0,1) is enforced, the network might neglect the reconstruction of this representation towards the original input. This may lead to blurry reconstructions and to representations that are difficult to interpret, as they follow the normal Gaussian distribution N(0,1) more than the underlying data itself.

According to aspects of the current subject matter, a prior adjusted variational autoencoder is provided. The prior adjusted variational autoencoder takes into account that not all attributes in the dataset naturally follow a normal Gaussian distribution N(0,1). The attributes from the data in the dataset are separated into two independent parts in which elements in one part share group characteristics within a group. According to the variational autoencoder representation, the representation of the attributes of the first part should be encoded close together for elements of one group. Thus, the representations of the first part within one group are represented by a group-specific Gaussian-distribution N(mu_g, sigma_g), where mu_g is the mean and sigma_g is the variance. To find mu_g and sigma_g, the group information is used as input (e.g., the images that show the same digit), which is referred to as group-level supervision. mu_g and sigma_g are calculated from the individual mu_i and sigma_i as encoded by the variational autoencoder for all elements i that belong to the group g. The result is a distribution in the representation that behaves similarly to a mixture of Gaussians, where for each group in the data batch (e.g., each digit value) there is one Gaussian component.

Other attributes of the data in the dataset do not depend on the group, such as the line thickness of a written digit, and the associated data elements continue to follow the normal Gaussian distribution N(0,1). Thus, according to aspects of the current subject matter, the attributes of the data in the dataset is split into two parts: a first part that represents group-specific attributes (e.g., the digit value) and a second part that represents group-unspecific attributes (e.g., the line thickness). This representation introduces a flexibility in which group-specific attributes are close to elements within the group in the first part instead of being close to an arbitrarily chosen point (e.g., 0), thus allowing the data to be represented in a more meaningful way and to have a lower loss in the representation of the data due to the individual elements being closer to a target distribution N(mu_g, sigma_g).

According to aspects of the current subject matter, the prior normal Gaussian distribution N(0,1) is adjusted, leaving the encoded representations unchanged. The group-specific representations or attributes of the individual data samples are not summarized in a common group-specific representation for every group, resulting in the ability to representing all group-specific attributes in the group-specific representation, even if the group specific attributes vary slightly within the group, because all group elements are still represented with their individual representation and it is not necessary to force one group-representation on all group-elements. As well as producing a more meaningful representation, this improves privacy aspects as it is possible to distinguish between group-specific and group-unspecific attributes in the data.

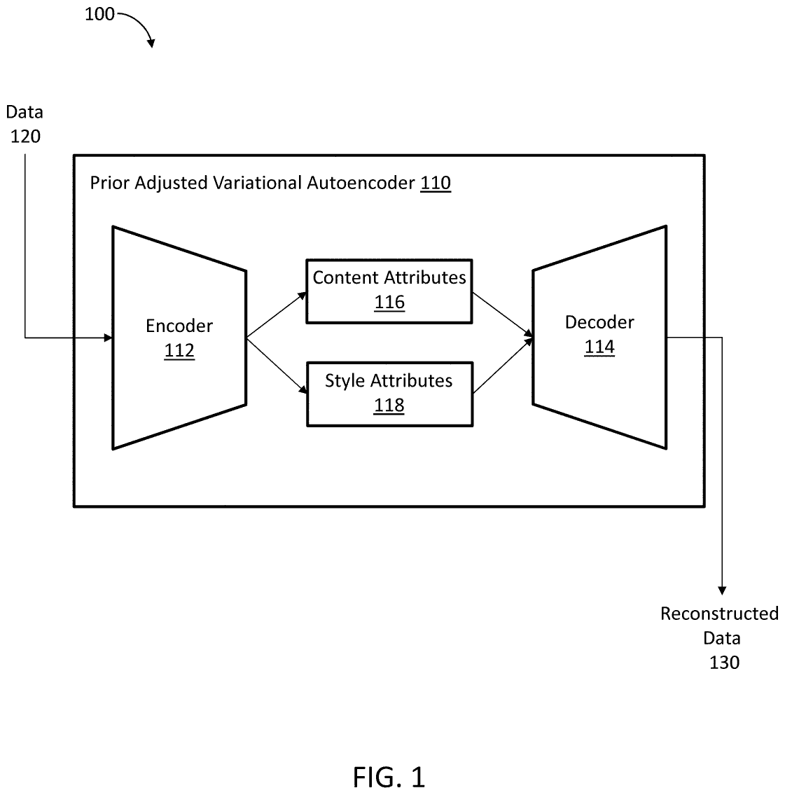

FIG. 1 is a block diagram of a system 100 depicting aspects of a prior adjusted variational autoencoder 110 consistent with implementations of the current subject matter. In some implementations, the prior adjusted variational autoencoder 110 includes an encoder 112 and a decoder 114. The encoder 112 receives data 120. The encoder 112 subsequently generates probability distributions associated with the data 120. The encoder 112 creates a probability distribution for the latent variables. From this probability distribution, a point in the latent space is sampled that is used as input for the decoder 114. The decoder 114 then generates reconstructed data 130 from the samples. The encoder 112 predicts the parameters mu and sigma necessary to parameterize the Gaussian distribution N(mu, sigma). A sample is then generated by sampling a random variable epsilon from N(0,1) and calculating the sample as mu+epsilon*sigma.

Consistent with implementations of the current subject matter, the probability distributions generated by the encoder 112 include content attributes 116 and style attributes 118. The content attributes 116 refer to the group-specific attributes, and the style attributes 118 refer to the group-unspecific attributes. The data elements associated with the style attributes 118 follow a normal Gaussian distribution N(0,1).

The content attributes 116 include the attributes that share group characteristics. Each individual data element within the first group is encoded by the encoder 112 as mu_i and sigma_i. For a group (e.g., each group) in the data batch, a representation N(mu_g, sigma_g) is calculated from the individual mu_i, sigma_i of the data elements within the group g, where mu_g is the mean and sigma_g is the variance. According to implementations, group-level supervision techniques are used to find mu_g and sigma_g with the group information used as input. The result is a distribution in the representation that behaves similarly to a mixture of Gaussians, where for each group in the data batch (e.g., each digit value within the batch) there is one Gaussian component. The style attributes 118 include the attributes that are group independent, and thus the data elements associated with the style attributes follow the normal Gaussian distribution N(0,1).

Consistent with implementations of the current subject matter, the encoder 112 is trained to encode data elements that share a group close together, and therefore close to the group-specific adjusted prior. In some implementations, the encoder 112 is a first neural network, and the decoder 114 is a second neural network. The first neural network can be separate and different from the second neural network. The data 120 may include records and/or may be at least one of text and images. Although text and images are described, in alternate implementations the data 120 may include any other type of data, such as audio, video, and/or combinations thereof. The data 120 may be confidential and/or privileged. Throughout the training, the network learns to separate the attributes of the data into group-related and group-unrelated attributes and learns to encode the group-related attributes in the content attributes part (116) and the group unrelated attributes in the style attributes part (118).

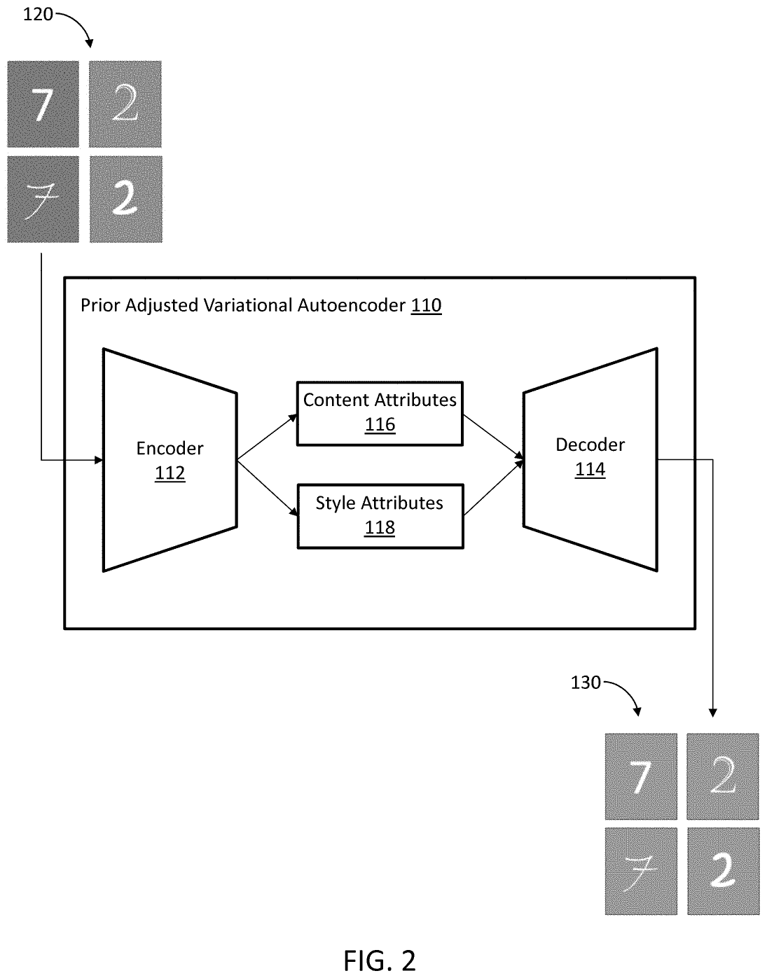

FIG. 2 illustrates aspects an example implementation of the prior adjusted variational autoencoder 110 consistent with implementations of the current subject matter. The data 120 in this example includes four data elements of numerical digits. The data 120 is inputted into encoder 112, which generates probability distributions associated with the data 120. A latent variable is sampled from the probability distributions, and the decoder 114 generates reconstructed data 130 from the samples.

Consistent with implementations of the current subject matter, the probability distributions generated by the encoder 112 include content attributes 116 and style attributes 118. According to implementations, a loss calculation is performed for each of the content attributes 116 and the style attributes 118. For the content attributes 116, the loss calculation may be based on a difference between content distribution and N(mu_g, sigma_g), where each individual data element within the first group is encoded by the encoder 112 as mu_i and sigma_i. According to implementations, group-level supervision techniques are used to find mu_g and sigma_g with the group information is used as input. According to aspects of the current subject matter, the group information is used to calculate the loss function in the content latent space. For each respective group, the distance between the encodings with the respective group representation are calculated.

For the style attributes 118, the loss calculation is based on a difference between style variables (e.g., the distribution of style attributes) and the normal Gaussian distribution N(0,1). The style variables are group-unrelated attributes, such as line thickness or writing angle (referring to the example with numerical digits).

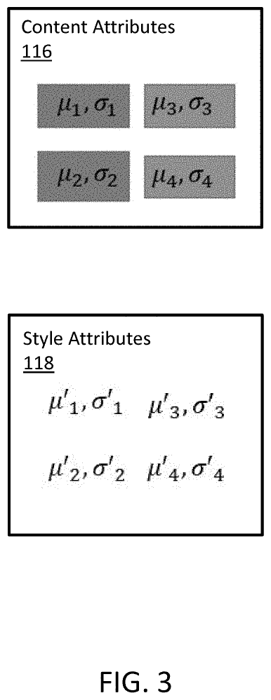

FIG. 3 illustrates additional aspects of the content attributes 116 and the style attributes 118 consistent with implementations of the current subject matter. For each of the four data elements (the data 120) shown in FIG. 2, mu_i and sigma_i as well as mu′_i and sigma′_i are generated by the encoder 112. Samples from the probability distributions are used by the decoder 114 to reconstruct the data, generating the reconstructed data 130.

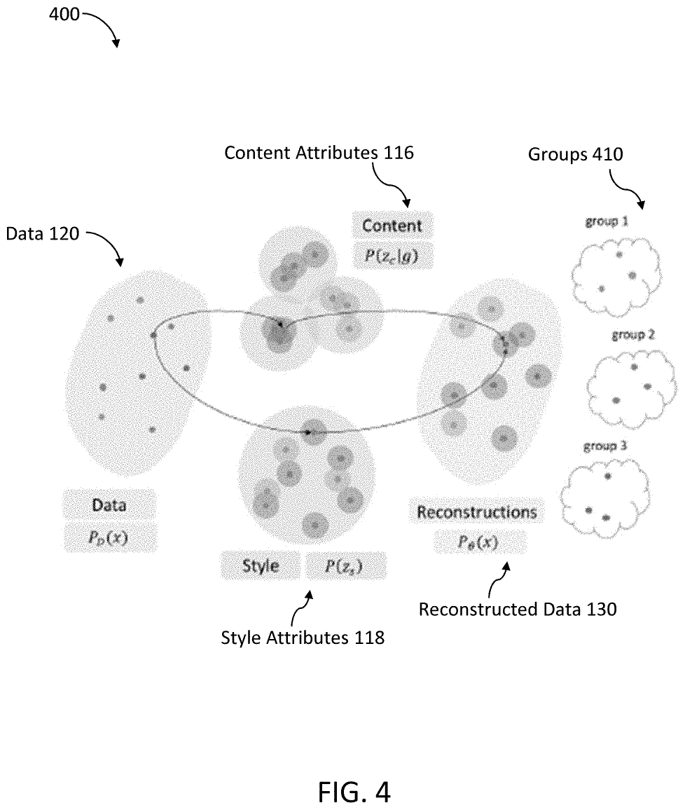

FIG. 4 is a diagram depicting an example data representation 400 consistent with implementations of the current subject matter. Data 120 includes input data to the prior adjusted variational autoencoder 110 consistent with implementations of the current subject matter. The attributes of data elements of the data 120 may be separated into two groups in which elements in a first group share group characteristics (as represented by the content attributes 116) and elements in a second group are group independent (as represented by the style attributes 118).

The encoder 112 optimizes its parameters to minimize a customized loss function. The loss function is minimized if content-related information is encoded in the content latent space. This occurs because the loss in the content latent space is minimized if for each group the encodings for elements of this group are close together. If information is encoded in the content latent space that is constant within a group, the encodings will mostly be close together. Therefore, the encoder 112 encodes information that is constant within a group in the content latent space in order to minimize the loss.

For the reconstruction, re-parameterized encodings are taken as input for the decoder 114. The decoder 114 creates reconstruction images. To optimize the decoder 114, a loss between the reconstructed data and the input data is calculated. As the decoder 114 wants to minimize this loss and optimizes its parameters accordingly, the reconstruction will improve with each iteration. Because the decoder 114 only has the encodings as input, the encodings need to carry meaningful information about the original input data. Therefore, the encoder 112 conserves as much information as possible when encoding the input data.

Groups 410 are shown as an example representation of the data 120 grouped into various groups. The groups may depend on the type of data. For example, if the data 120 includes image data of single digits (e.g., 0,1,2,3 . . . 9), one group may be all the ones, a second group may include all of the twos, and so on. For each iteration, the elements that form a group are known but the corresponding class is not known (e.g., it is not known that the group of ones belongs to the class one). In a different application, a group may include different images of one person. In such an example, group information is obtained, for example, from a video from which images (e.g., frames) of one person may be obtained without knowing the identity of the person to train the model.

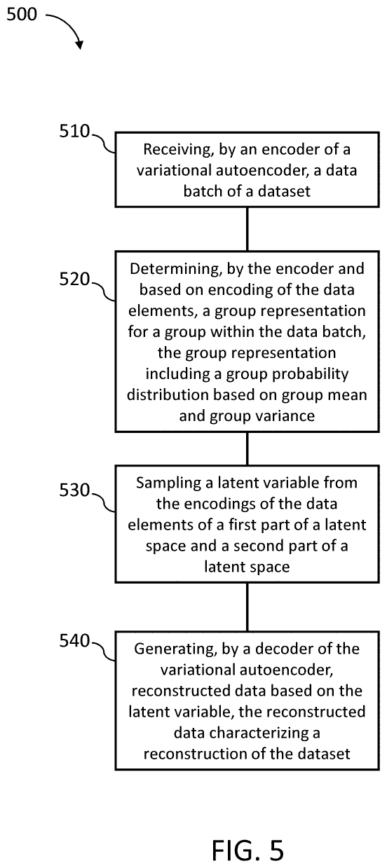

FIG. 5 depicts a flowchart 500 illustrating a process consistent with implementations of the current subject matter. The process depicted by the flowchart 500 may be implemented by the prior adjusted variational autoencoder 110.

At 510, an encoder of a variational autoencoder may receive a dataset. For example, and with reference to FIG. 1, the encoder 112 of the variational autoencoder 110 may receive data 120. The data 120 may include, for example, text, images, audio, and/or video. Consistent with implementations of the current subject matter, the data 120 may have some continuous attributes that may be represented with a continuous distribution, for example a normal Gaussian distribution N(0,1). However, a normal Gaussian distribution N(0,1) may not be a natural and/or appropriate distribution for other attributes of the data 120. For example, other attributes of the dataset may be inherently discrete.

At 520, the encoder, such as the encoder 112, encodes the data elements of a data batch and calculates a group-representation for the content attributes. The encoder encodes data elements of the data batch, the encoding including a mean and a variance for a probability distribution of the data elements. The encoder may be trained to find representations that induce a low loss. For the probability distribution of the content attributes, a group representation is calculated for a group, that will follow the Gaussian distribution N(mu_g, sigma_g). The group representation includes a group probability distribution based on a group mean and a group variance. The style attributes may have a similar distribution to a normal Gaussian distribution having a mean of zero and a variance of one. For example, the similar distribution may have a mean close to or near zero and a variance close to or near the value of one.

At 530, a latent variable from the encoding of the data elements of a first part of a latent space and a second part of a latent space is sampled. For the representation, a latent variable is sampled from the encodings of the content attributes and the style attributes.

At 540, a decoder of the variational autoencoder may generate reconstructed data. For example, the decoder 114 of the variational autoencoder 110 may generate the reconstructed data based on the sampled latent variable. The reconstructed data may characterize a reconstruction of the data input.

Consistent with implementations of the current subject matter, the encoder, such as the encoder 112, may be a first neural network. Consistent with implementations of the current subject matter, the decoder, such as the decoder 114, may be a second neural network.

According to aspects of the current subject matter, a loss calculation for each data element may be determined. The loss calculation may be based on a difference between content distribution and N(mu_g, sigma_g) and the difference between style distribution and N(0,1). According to aspects of the current subject matter, the group information is used to calculate N(mu_g, sigma_g) that is used to calculate the loss function in the content latent space. For each data element, the distance between the encoding and the respective calculated group distribution (N(mu_g, sigma_g)) is calculated. For the style attributes, the loss calculation is based on a difference between style distributions and the normal Gaussian distribution N(0,1).

Consistent with implementations of the current subject matter, group-level information may be used to disentangle the content of an image from its style. Rather than assume that elements that share a group also have to share the same representation in the part of the latent space encoding the content information, the prior adjusted variational autoencoder consistent with implementations of the current subject matter does not require elements of the same group to share the same latent representation for parts of the latent space and instead only encourages the elements to have a similar representation. The standard normal prior commonly used in variational autoencoders is adjusted such that a new prior for each group is calculated using the additional information from the weak supervision. The model then learns to find representations for elements sharing a group that will be encoded close together and close to the adjusted prior, without requiring these representations to be identical. This behavior gives more flexibility in the encoding of the content related features, allowing to also encode strongly content dependent elements in the content part of the latent space that would have to be encoded in the style part otherwise.

In group-level supervision, information about one hidden factor of variation that is defined to be the content is available, while the unknown factors of variation are considered to belong to the style. In every batch, it is known which elements form a group by sharing the same hidden factor of variation, but the value of this hidden factor is not known. The approach of finding shared representations of the content information within groups, as done in earlier systems or networks, can lead to problems. For example, with the use of a shared representation, it is only possible to encode information in the content part of the latent space that does not change within each group. However, many content relevant or content dependent features may not always be constant for every element in the group. For example, a hair style (e.g., long or short hair) can change over time, but it is still related to the identity (e.g., content). Using a shared representation for every group, it would not be possible to encode information like the hair style within the content part of the latent space.

The prior adjusted variational autoencoder, according to aspects of the current subject matter, makes use of the weak supervision signal in the form of group-level supervision, to update a prior belief from the standard normal Gaussian towards an adjusted prior. In the adjusted prior, each group in a batch has its own and unique mixture component. Elements sharing a group are encoded close to their respective adjusted prior and therefore close together, without requiring these elements to share an identical representation. With this approach, it is then also possible to encode strongly content related features that do not necessarily need to be constant within each group in the content part of the latent space.

The prior adjusted variational autoencoder provided herein adjusts the prior for the part of the latent space that is responsible for representing the content of an image. By doing so, the discrete content will have a representation of a mixture of Gaussians, allowing the number of mixture components and the distribution in the latent space to be determined freely, depending on the input data, the data representation in the content latent space, and the weak supervision. The model is encouraged to cluster elements that share a group close together.

A variational autoencoder is trained to encode the image information in a latent space z by maximizing the evidence lower bound (ELBO) of the data log-likelihood, as represented by equation (1):

p(x)≥ [symbol] _{z≈q}_{_{ϕ}}( [symbol] |x)[p_{θ}(x|z)−D_{KL}(q_{ϕ}(z|x)|p(z))] (1)

In equation 1, q_{ϕ}(z|x) denotes the predicted probability distribution for z by the encoder that is parameterized by the parameters ϕ, and p_{θ}(x|z) is the predicted probability density for the data in the image space x by the decoder parameterized by the parameters θ.

According to aspects of the current subject matter, the hidden factors of variation that are responsible for creating an image are separable in content related (also referred to herein as group-specific) and content unrelated information referred to herein as style (also referred to herein as group-unspecific). Content related information stays similar for all elements sharing the same content, while the style information is content independent. In the D-dimensional latent space z∈R^{D}, there are D_{c} latent dimensions, z_{c}∈R^{D}^{_{c}}, that will encode the content related features of the images, and Dₛ latent dimensions, zₛ∈R^{D}^{ₛ}, that will encode the style related features of the image, such that D_{c}+Dₛ=D. z_{c} is independent from zₛ. Equation (1) can then be formulated as follows in equation (2), where the prior for z_{c}, p(z_{c}|g,z̅_{c}), depends on the group information g as well as the observed predictions for z_{c}, z̅_{c}:

p(x)≥ [symbol] _{z≈q}_{_{ϕ}}(z|x)p_{θ}(x|z)−βD_{KL}(q_{ϕ}(z_{c}|x)|p(z_{c}|g,z̅_{c}))−βD_{KL}(q_{ϕ}(zₛ|x)|p(zₛ)) (2)

A coefficient β is included in front of the KL-loss (the Kullback-Leibler divergence loss that quantifies differences between probability distributions). This hyperparameter is incorporated to gain control of the amount of information encoded in either latent space, by penalizing a high KL-loss for both latent spaces.

The prior for zₛ is the standard normal Gaussian distribution N(0,1). Because there is no further information about the distribution of the style for the unobserved factors of variation, further knowledge cannot be used to update the prior distribution. The content information g, however, depends on the group-level or content information. Therefore, this additional knowledge may be incorporated in the prior believe to adjust the prior accordingly.

The ideal adjusted prior distribution should be the most likely distribution that unobserved values of the particular group might have. This can be calculated by including knowledge of the predicted distributions for z_{c} as given by the encoding q_{ϕ}( [symbol] _{c}|x) in combination with the group-level information g. A further assumption is that all elements z_{c}⁽ⁱ⁾ are independent and identically distributed given the group-level information g. The posterior predictive distribution (also referred to as ppd) may then be calculated, which serves as a better estimate of the group prior p(z|g) than the standard normal prior.

Consistent with implementations of the current subject matter, an estimate of the distribution of one point in the latent space z_{c} is the posterior predictive distribution of z_{c}. Each group has its own posterior predictive distribution, such that the posterior predictive distribution is calculated separately for each group.

z′_{c} is a new and unobserved data point, and z̅_{c} are the data points observed so far for the elements belonging to a group G∈ [symbol] for each batch separately. The posterior predictive distribution for z′_{c} is represented by equation (3):

$$p ( {𝓏}_{c}^{′} \vert {\overline{𝓏}}_{c} ) = {\int }_{- ∞}^{∞} p ( {𝓏}_{c}^{′} , μ \vert {\overline{𝓏}}_{c} ) d μ = {\int }_{- ∞}^{∞} {\underbrace{p ( {𝓏}_{c}^{′} \vert μ )}}_{likelihood} {\underbrace{p ( μ \vert {\overline{𝓏}}_{c} )}}_{posterior} d μ \qquad ( 3 )$$

The posterior for the mean of one group is given by the following equation, according to Bayes theorem as represented by equation (4):

$$p ( μ \vert {\overline{𝓏}}_{c} ) ∝ p ( {\overline{𝓏}}_{c} \vert μ ) p ( μ ) = p ( μ ) {\prod }_{i ϵ G} p ( {𝓏}_{c}^{( i )} \vert μ ) \qquad ( 4 )$$

The assumption for p(μ) is the standard normal prior [symbol] (0,1), such that p(μ)=N(μ₀=0, Σ₀=1). Each likelihood term p( [symbol] _{c}⁽ⁱ⁾|μ) is also Gaussian distributed with p( [symbol] _{c}⁽ⁱ⁾|μ) = [symbol] (μ,Σ_{c}⁽ⁱ⁾). The posterior is therefore also Gaussian distributed and is given by p(μ| [symbol] _{c})= [symbol] (μ_{G}, Σ_{G}), where μ_{G} and Σ_{G} are represented by equation (5):

$$\begin{matrix}{μ}_{G}^{T} {Σ}_{G}^{- 1} = {\sum }_{i ϵ G} {( {μ}_{c}^{( i )} )}^{T} {( {Σ}_{c}^{( i )} )}^{- 1} + {μ}_{0}^{T} {Σ}_{0}^{( - 1 )} , & {Σ}_{G}^{- 1} = {\sum }_{i ϵ G} {( {Σ}_{c}^{( i )} )}^{- 1} + {Σ}_{0}^{- 1}\end{matrix} \qquad ( 5 )$$

To calculate the likelihood p( [symbol] ′_{c}|μ), the most likely variance that a new data point [symbol] ′_{c} may have is estimated. The mean of all observed variances for the particular group is represented by equation (6):

Σ′_{c}=1/NΣᵢ₌₀^{N}Σ_{c}⁽ⁱ⁾ (6)

The posterior predictive distribution can be calculated as shown in equation (7):

p( [symbol] ′_{c}| [symbol] _{c})=N(μ_{G}, Σ′_{c}+Σ_{G}) (7)

A hyperparameter γ is introduced for the model to encode content independent information in the style-part zₛ of the latent space z. The hyperparameter γ is incorporated in the KL-loss of the content part z_{c}, where it penalizes the mean square error of the two means of q(z|x) and p(z|g, [symbol] _{c}). The KL-loss for the content part of the latent space is represented by equation (8):

$${D}_{K L} ( p ( {𝓏}_{c} \vert g ) \vert q ( {𝓏}_{c} \vert x ) ) = {D}_{K L} ( N ( {μ}_{G} , {Σ}_{G} ) \vert N ( {μ}_{c} , {Σ}_{c} ) ) \qquad ( 8 )$$

$$= 0.5 ( log ( {Σ}_{G} / {Σ}_{c} ) + \frac{{Σ}_{G} + {γ ( {μ}_{G} - {μ}_{c} )}^{2}}{{Σ}_{c}} - 1 )$$

With the use of the hyperparameter γ>1, it will be cheaper for the model to encode content unrelated information in the style part of the latent space than in the content part. However, the content related information may still be encoded in the content part because data points sharing the same content will still be encoded close together in z_{c}, such that the hyperparameter γ will increase the loss only slightly, which is compensated by allowing the flexibility of the prior mean in z_{c}.

The value of γ has an influence on the amount of information that is stored in either of the two latent spaces. A higher value of γ leads the encoder to encode more content related information in zₛ in order to reduce the loss. A lower value of γ, however, leads the encoder to encode more information in z_{c}, as it does not have any disadvantage compared to encoding the information in zₛ, and might even instead have a slight advantage, as soon as there is some relation to the content in the information.

The prior adjusted variational autoencoder 110 consistent with implementations of the current subject matter can be used for the disentanglement of content and style. Content related information is encoded in the content part of the latent space and is not limited to encoding of information that stays constant within a content category. The learned representations are split between content and style in a natural way because strongly content dependent information is encoded in the content part of the latent space and not in the style part.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. A system comprising: a memory storing a data structure that comprises a machine learning model, the machine learning model configured to: receive, by an encoder of a variational autoencoder, a data batch of a dataset, the data batch including data elements; determine, based on encoding of the data elements, a group representation for a group in the data batch, the encoding including a mean and a variance for a probability distribution of the data elements, the group representation including a group probability distribution based on a group mean and a group variance; sample a latent variable from the encodings of the data elements of a first part of a latent space and a second part of the latent space; and generate, by a decoder of the variational autoencoder, reconstructed data based on the latent variable, the reconstructed data characterizing a reconstruction of the dataset.

Example 2. The system of Example 1, wherein the encoder encodes the data elements of the data batch, the encoding comprising determining the mean and the variance for the probability distribution of the data elements.

Example 3. The system of Example 1 or 2, wherein the first part of the latent space comprises content attributes of the dataset, the content attributes sharing one or more group characteristics, wherein the second part of the latent space comprises style attributes of the dataset.

Example 4. The system of Example 3, wherein the machine learning model is further configured to train the encoder to find representations for the data elements of the dataset, and encode the data elements that share a group close together in the first part of the latent space.

Example 5. The system of Example 3 or 4, wherein a representation of the data elements associated with the style attributes are distributed in accordance with a normal Gaussian distribution having a mean of zero and a variance of one.

Example 6. The system of any of Examples 3-5, wherein the machine learning model is further configured to determine a loss calculation for the group, the loss calculation including a loss quantification of the first part of the latent space and of the second part of the latent space, wherein the loss calculation of the first part of the latent space is based on group information.

Example 7. The system of any of Examples 1-6, wherein the probability distribution is determined based on group-level supervision.

Example 8. The system of any of Examples 1-7, wherein the encoder comprises a first neural network, wherein the decoder comprises a second neural network.

Example 9. A method comprising: receiving, by an encoder of a variational autoencoder, a data batch of a dataset, the data batch including data elements; determining, based on encoding of the data elements, a group representation for a group in the data batch, the encoding including a mean and a variance for a probability distribution of the data elements, the group representation including a group probability distribution based on a group mean and a group variance; sampling a latent variable from the encodings of the data elements of a first part of a latent space and a second part of the latent space; and generating, by a decoder of the variational autoencoder, reconstructed data based on the latent variable, the reconstructed data characterizing a reconstruction of the dataset.

Example 10. The method of Example 9, wherein the encoder encodes the data elements of the data batch, the encoding comprising determining the mean and the variance for the probability distribution of the data elements.

Example 11. The method of Example 9 or 10, wherein the first part of the latent space comprises content attributes of the dataset, the content attributes sharing one or more group characteristics, wherein the second part of the latent space comprises style attributes of the dataset.

Example 12. The method of Example 11, the method further comprising training the encoder to find representations for the data elements of the dataset, and encode the data elements that share a group close together in the first part of the latent space.

Example 13. The method of Example 11 or 12, wherein a representation of the data elements associated with the style attributes are distributed in accordance with a normal Gaussian distribution having a mean of zero and a variance of one.

Example 14. The method of any of Examples 11-13, the method further comprising determining a loss calculation for the group, the loss calculation including a loss quantification of the first part of the latent space and of the second part of the latent space, wherein the loss calculation of the first part of the latent space is based on group information.

Example 15. The method of any of Examples 9-14, wherein the probability distribution is determined based on group-level supervision.

Example 16. The method of any of Examples 9-15, wherein the encoder comprises a first neural network, wherein the decoder comprises a second neural network.

Example 17. A non-transitory computer-readable storage medium including program code, which when executed by at least one data processor, causes operations comprising: receiving, by an encoder of a variational autoencoder, a data batch of a dataset, the data batch including data elements; determining, based on encoding of the data elements, a group representation for a group in the data batch, the encoding including a mean and a variance for a probability distribution of the data elements, the group representation including a group probability distribution based on a group mean and a group variance; sampling a latent variable from the encodings of the data elements of a first part of a latent space and a second part of the latent space; and generating, by a decoder of the variational autoencoder, reconstructed data based on the latent variable, the reconstructed data characterizing a reconstruction of the dataset.

Example 18. The non-transitory computer-readable storage medium of Example 17, wherein the first part of the latent space comprises content attributes of the dataset, the content attributes sharing one or more group characteristics, wherein the second part of the latent space comprises style attributes of the dataset.

Example 19. The non-transitory computer-readable storage medium of Example 18, the operations further comprising training the encoder to find representations for the data elements of the dataset, and encode the data elements that share a group close together in the first part of the latent space.

Example 20. The non-transitory computer-readable storage medium of Example 18 or 19, wherein a representation of the data elements associated with the style attributes are distributed in accordance with a normal Gaussian distribution having a mean of zero and a variance of one.

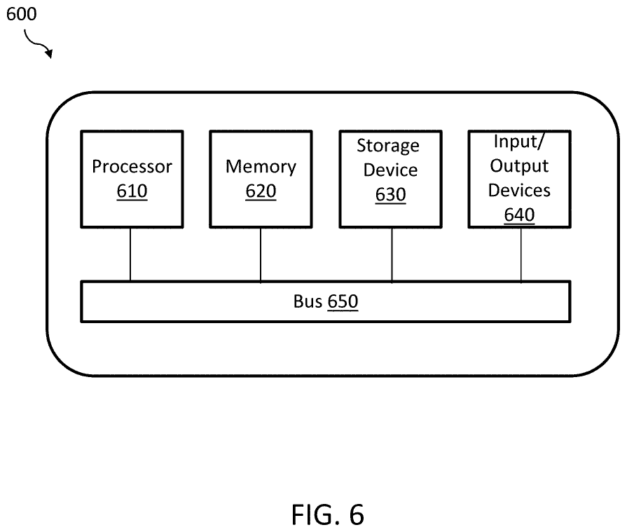

FIG. 6 depicts a block diagram illustrating a computing system 600 consistent with implementations of the current subject matter. In some implementations, the current subject matter may be configured to be implemented in a system 600.

As shown in FIG. 6, the computing system 600 can include a processor 610, a memory 620, a storage device 630, and input/output devices 640. The processor 610, the memory 620, the storage device 630, and the input/output devices 640 can be interconnected via a system bus 650. The processor 610 is capable of processing instructions for execution within the computing system 600. Such executed instructions can implement one or more components of, for example, the system 100. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a floppy disk device, a hard disk device, an optical disk device, or a tape device, or other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some implementations of the current subject matter, the computing system 600 can be used to execute various interactive computer software applications that can be used for organization, analysis and/or storage of data in various (e.g., tabular) format (e.g., Microsoft Excel®, and/or any other type of software). Alternatively, the computing system 600 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 640. The user interface can be generated and presented to a user by the computing system 600 (e.g., on a computer screen monitor, etc.).

One or more aspects or features of the subject matter described herein can be realized in digital electronic circuitry, integrated circuitry, specially designed application-specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
a memory storing a data structure that comprises a machine learning model, the machine learning model configured to:
receive, by an encoder of a variational autoencoder, a data batch of a dataset, the data batch including data elements;
determine, based on encoding of the data elements, a group representation for a group in the data batch, the encoding including a mean and a variance for a probability distribution of the data elements, the group representation including a group probability distribution based on a group mean and a group variance;
sample a latent variable from the encodings of the data elements of a first part of a latent space and a second part of the latent space; and
generate, by a decoder of the variational autoencoder, reconstructed data based on the latent variable, the reconstructed data characterizing a reconstruction of the dataset.

2. The system of claim 1, wherein the encoder encodes the data elements of the data batch, the encoding comprising determining the mean and the variance for the probability distribution of the data elements.

3. The system of claim 1, wherein the first part of the latent space comprises content attributes of the dataset, the content attributes sharing one or more group characteristics, wherein the second part of the latent space comprises style attributes of the dataset.

4. The system of claim 3, the machine learning model further configured to:
train the encoder to find representations for the data elements of the dataset, and encode the data elements that share a group close together in the first part of the latent space.

5. The system of claim 3, wherein a representation of the data elements associated with the style attributes are distributed in accordance with a normal Gaussian distribution having a mean of zero and a variance of one.

6. The system of claim 3, the machine learning model further configured to:
determine a loss calculation for the group, the loss calculation including a loss quantification of the first part of the latent space and of the second part of the latent space, wherein the loss calculation of the first part of the latent space is based on group information.

7. The system of claim 1, wherein the probability distribution is determined based on group-level supervision.

8. The system of claim 1, wherein the encoder comprises a first neural network, wherein the decoder comprises a second neural network.

9. A method, comprising:
receiving, by an encoder of a variational autoencoder, a data batch of a dataset, the data batch including data elements;
determining, based on encoding of the data elements, a group representation for a group in the data batch, the encoding including a mean and a variance for a probability distribution of the data elements, the group representation including a group probability distribution based on a group mean and a group variance;
sampling a latent variable from the encodings of the data elements of a first part of a latent space and a second part of the latent space; and
generating, by a decoder of the variational autoencoder, reconstructed data based on the latent variable, the reconstructed data characterizing a reconstruction of the dataset.

10. The method of claim 9, wherein the encoder encodes the data elements of the data batch, the encoding comprising determining the mean and the variance for the probability distribution of the data elements.

11. The method of claim 9, wherein the first part of the latent space comprises content attributes of the dataset, the content attributes sharing one or more group characteristics, wherein the second part of the latent space comprises style attributes of the dataset.

12. The method of claim 11, further comprising:
training the encoder to find representations for the data elements of the dataset, and encode the data elements that share a group close together in the first part of the latent space.

13. The method of claim 11, wherein a representation of the data elements associated with the style attributes are distributed in accordance with a normal Gaussian distribution having a mean of zero and a variance of one.

14. The method of claim 11, further comprising:
determining a loss calculation for the group, the loss calculation including a loss quantification of the first part of the latent space and of the second part of the latent space, wherein the loss calculation of the first part of the latent space is based on group information.

15. The method of claim 9, wherein the probability distribution is determined based on group-level supervision.

16. The method of claim 9, wherein the encoder comprises a first neural network, wherein the decoder comprises a second neural network.

17. A non-transitory computer-readable storage medium including program code, which when executed by at least one data processor, causes operations comprising:
receiving, by an encoder of a variational autoencoder, a data batch of a dataset, the data batch including data elements;
determining, based on encoding of the data elements, a group representation for a group in the data batch, the encoding including a mean and a variance for a probability distribution of the data elements, the group representation including a group probability distribution based on a group mean and a group variance;
sampling a latent variable from the encodings of the data elements of a first part of a latent space and a second part of the latent space; and
generating, by a decoder of the variational autoencoder, reconstructed data based on the latent variable, the reconstructed data characterizing a reconstruction of the dataset.

18. The non-transitory computer-readable storage medium of claim 17, wherein the first part of the latent space comprises content attributes of the dataset, the content attributes sharing one or more group characteristics, wherein the second part of the latent space comprises style attributes of the dataset.

19. The non-transitory computer-readable storage medium of claim 18, the operations further comprising:
training the encoder to find representations for the data elements of the dataset, and encode the data elements that share a group close together in the first part of the latent space.

20. The non-transitory computer-readable storage medium of claim 18, wherein a representation of the data elements associated with the style attributes are distributed in accordance with a normal Gaussian distribution having a mean of zero and a variance of one.
